(19) United States
(12) Patent Application Publication
(10) Pub. No.: US 2007/0299648 A1
(43) Pub. Date: Dec. 27, 2007

(54) Reuse of learned information to simplify functional verification of a digital circuit

(76) Inventors: Jeremy R. Levitt, San Jose, CA (US); Christophe G. Gauthron, Mountain View, CA (US); Clark W. Barrett, New York, NY (US); Lawrence Curtis Widdoes JR., San Jose, CA (US)

Correspondence Address: Trellis Intellectual Property Law Group, PC, 1900 EMBARCADERO ROAD, SUITE 109, PALO ALTO, CA, 94303, US

(21) Appl. No.: 10/340,555

(22) Filed: Jan. 10, 2003

(51) Int. Cl. G06F 9/45

(52) U.S. Cl. 703/22

(57) ABSTRACT

A computer is programmed in accordance with the invention to automatically analyze a digital circuit, to check if the digital circuit can enter a target state starting from a start state, by reusing information learned during a another analysis, checking if the same digital circuit can enter the same or different target state from a different start state. Use of learned information in accordance with the invention simplifies the analysis of the digital circuit (e.g. by allowing skipping one or more analysis acts). The learned information may be stored in a database. Depending on the embodiment, the two or more analyses may check on operation of the digital circuit for the same or different numbers of cycles.

### CROSS-REFERENCE TO COMPUTER PROGRAM LISTING APPENDIX

Appendices A1-A14 are located in a single file “APPENDIXA.txt” in one CD-ROM (of which two identical copies are attached hereto), and these appendices form a part of the present disclosure and are incorporated by reference herein in their entirety.
Volume in drive D is 030110_{—}1743
Volume Serial Number is 4596-85E4

Directory of D:\

| | |
|---|---|
| 01/10/2003 11:36a | 22,979 APPENDIXA.txt |

| | |
|---|---|
| 1 File(s) | 22,979 bytes |

| | |
|---|---|
| 0 Dir(s) | 0 bytes free |

Appendices A1-A14 are described below, in the Detailed Description section. The software in Appendix A14 is used in some embodiments of the invention with a C Compiler, such as GNU Compiler (e.g. gcc 3.2), described on the Internet at http://www.gnu.org/software/gcc/gcc.html. The software may be used to program any computer well known in the art, such as a SUN Solaris 2.7 machine with 500 MB memory, to create a programmed computer embodiment of the type described herein.

A portion of the disclosure of this patent document contains material that is subject to copyright protection. The copyright owner has no objection to the facsimile reproduction by anyone of the patent document or the patent disclosure, as it appears in the in the Patent and Trademark Office patent files or records, but otherwise reserves all copyright rights whatsoever.

### CROSS-REFERENCE TO RELATED APPLICATIONS

This application is related to and incorporates by reference herein in their entirety, each of the following commonly owned and copending U.S. patent applications:

Application Ser. No., Unknown, attorney docket [0IN004 US] filed on Jan. 10, 2003, entitled “Selection of Initial States for Formal Verification” by James Andrew Garrard Seawright et al.

Application Ser. No. 09/635,598, attorney docket [0IN005-1C US], filed Aug. 9, 2000, entitled “A Method For Automatically Generating Checkers for Finding Functional Defects in a Description of a Circuit” by Tai An Ly et al.; and

Application Ser. No. 09/849,005, attorney docket [0IN006-1C US], filed May 4, 2001, entitled “Method for Automatically Searching for Functional Defects in a Description of a Circuit” by Chian-Min Richard Ho, et. al.; and

Application Ser. No. 10/174,379, attorney docket [0IN003 US], filed Jun. 17, 2002, entitled “Measure of Analysis Performed In Property Checking” filed by Jeremy Rutledge Levitt et al.

### BACKGROUND OF THE INVENTION

Modern digital electronic circuits are typically designed at the register-transfer (RTL) level in hardware description languages such as Verilog (see “The Verilog Hardware Description Language”, Third Edition, Don E. Thomas and Philip R. Moorby, Kluwer Academic Publishers, 1996) or VHDL (see “A Guide to VHDL”, Stanley Mazor and Patricia Langstraat, Kluwer Academic Publishers, 1992). A circuit description in such a hardware description language can be used to generate logic circuit elements (including logic gates and registers) as described, for example, in U.S. Pat. No. 5,661,661 granted to Gregory and Segal that is incorporated by reference herein in its entirety.

Such hardware description languages facilitate extensive simulation and emulation of the described circuit using commercially available products such as Verilog-XL available from Cadence Design Systems, San Jose, Calif., QuickHDL available from Mentor Graphics, Wilsonville, Oreg., Gemini CSX available from IKOS Systems, Cupertino, Calif., and System Realizer available from Quickturn Design Systems, Mountain View, Calif. These hardware description languages also facilitate automatic synthesis of ASICs (see “HDL Chip Design”, by Douglas J. Smith, Doone Publications, 1996; “Logic Synthesis Using Synopsys”, Pran Kurup and Taher Abbasi, Kluwer Academic Publishers, 1997) using commercially available products such as Design Analyzer and Design Compiler, available from Synopsys, Mountain View, Calif.

As described in “Architecture Validation for Processors”, by Richard C. Ho, C. Han Yang, Mark A. Horowitz and David L. Dill, Proceedings 22^{nd} Annual International Symposium on Computer Architecture, pp. 404-413, June 1995, “modern high-performance microprocessors are extremely complex machines which require substantial validation effort to ensure functional correctness prior to tapeout” (see page 404).

Recently, a formal verification method called bounded model checking (“BMC”) has been used to validate the functional correctness of large digital circuits. For example, the following two references describe BMC, and each is incorporated by reference herein in its entirety:
“Symbolic model checking without BDDs”, by A. Biere, A. Cimatti, E. M. Clarke, and Y. Zhu, Proceedings 5^{th} International Conference on Tools and Algorithms for Construction and Analysis of Systems, Amsterdam, The Netherlands, March 1999, pp. 193-207
“Bounded model checking using satisfiability solving”, by E. M. Clarke, A. Biere, R. Raimi and Y. Zhu, Formal Methods in System Design, Vol. 19, No. 1, pp. 7-34, 2001

BMC converts a sequential digital circuit to a C-cycle time-frame-expanded combinational circuit and uses a Boolean satisfiability (“SAT”) algorithm to check whether the time-frame-expanded circuit can violate a pre-determined property, starting from a given initial state. By systematically increasing C from 1 to a pre-determined limit, L, BMC determines the shortest stimulus sequence not greater than L cycles long that will cause the circuit to violate the property, starting from the given initial state, or else determines that no such sequence exists.

Many of the published approaches to SAT algorithms are based on the Davis-Putnam procedure, described in the following references, each of which is incorporated by reference herein in its entirety:
“A computing procedure for quantification theory”, by M. Davis and H. Putnam, Journal of the Association for Computing Machinery, Vol. 7, pp. 102-215, 1960
“A machine program for theorem proving”, by M. Davis, G. Logeman and D. Loveland, Communications of the ACM, Vol. 5, pp. 394-397, July 1962

Recently, advances in SAT algorithms have resulted in much faster and more efficient BMC implementations. For example, see the following references, each of which is incorporated by reference herein in its entirety:
“GRASP: A search algorithm for propositional satisfiability”, by J. P. Marques-Silva and K. A. Sakallah, IEEE Transactions on Computers, Vol. 48, pp. 506-521, May 1999.
“SATO: An efficient propositional prover”, by H. Zhang, Proceedings of the International Conference on Automated Deduction, pp. 272-275, July 1997.
“Chaff: Engineering an efficient SAT solver”, by M. W. Moskewicz, C. F. Madigan, Y. Zhao, L. Zhang and S. Malik, Proceedings of the 38^{th} ACM/IEEE Design Automation Conference (DAC), pp. 530-535, June 2001.
“SATIRE: A new incremental satisfiability engine”, by J. Whittemore, J. Kim and K. Sakallah, Proceedings of the 38^{th} ACM/IEEE Design Automation Conference (DAC), pp. 542-545, June 2001.
“Efficient conflict driven learning in a Boolean satisfiability solver”, Proceedings of the International Conference on Computer Aided Design (ICCAD), by L. Zhang, C. Madigan, M. Moskewicz and S. Malik, pp. 279-285, November 2001.
“Combining strengths of circuit-based and CNF-based algorithms for a high-performance SAT solver”, by M. K. Ganai, L. Zhang, P. Ashar, A. Gupta and S. Malik, ACM/IEEE Design Automation Conference (DAC), pp. 747-750, June 2002.
“Robust Boolean Reasoning for Equivalence Checking and Functional Property Verification”, by A. Kuehlmann, V. Paruthi, F. Krohm and M. K. Ganai, IEEE Transactions on Computer-Aided Design of Integrated Circuits and Systems, Vol. 21, Number 11, pp. 1377-1394, December 2002.

In general, the computational complexity of all SAT algorithms known to the inventors is exponential with respect to the maximum stimulus length, L, and also with respect to the number of circuit elements in the circuit under verification (see “Computing Science: Can't get no satisfaction”, by B. Hayes, American Scientist, Vol. 85, pp. 108-112, 1997, and “Computing Science: On the threshold”, by B. Hayes, American Scientist, Vol. 91, pp 12-17, 2003). Therefore, for large L (for example, 100 cycles) and for large circuits (for example, 1,000,000 gates), analysis of a single initial state using the most efficient BMC implementation may require several hours of CPU time using a typical computer available today such as a PowerEdge 1600SC server from Dell, Round Rock, Tex., based on the 2 GHz Xeon microprocessor from Intel, Santa Clara, Calif.

Some large digital circuits are so complex that certain modes of operation of the circuits cannot be reached within the range of analysis of existing BMC methods, starting from a single start state. For example, some large digital circuits contain internal counters which require more than 100 cycles to reach states which are indicative of corner-case modes of operation, starting from the reset state. For this reason, prior-art BMC functional verification methods may fail to detect some defective behaviors of large digital circuits and such circuits may fail when operated in the real world. Therefore, a method is needed which will simplify functional verification using BMC starting from multiple different start states.

### SUMMARY

A computer is programmed in accordance with the invention to automatically analyze a digital circuit, to check if the digital circuit can enter a target state starting from a start state, by reusing information learned during another analysis, checking if the same digital circuit can enter the same or different target state from a different start state. Use of learned information in accordance with the invention simplifies the analysis of the digital circuit (e.g. by allowing skipping one or more analysis acts). The learned information may be stored in a database. Depending on the embodiment, the two or more analyses may check on operation of the digital circuit for the same or different numbers of cycles.

### BRIEF DESCRIPTION OF THE DRAWINGS

FIGS. 1A and 1B illustrate, in a data flow diagram and a flow chart respectively, one embodiment of the invention.

FIGS. 1C and 1D illustrate an extension of the embodiment illustrated in FIGS. 1A and 1B.

FIG. 1E illustrates, in a flow chart, a variation of the method of FIG. 1B, wherein two analyses are performed concurrently.

FIG. 1F illustrates, in a data flow diagram, learning of information during an analysis of a digital circuit, and use of such learned information in accordance with the invention, when performing another analysis.

FIG. 2A illustrates, in a flow chart, one specific embodiment of the invention that represents the learned information of FIG. 1F in the form of conjunctive normal form (CNF) clauses and applies a SAT solver using the clauses.

FIG. 2B illustrates, in a block diagram, learned information held in a memory of a programmed computer that performs the method illustrated in FIG. 2A.

FIG. 3 illustrates, one implementation of the flow chart of FIG. 2A in which the programmed computer performs time-frame expansion of a netlist for a number of cycles specified by user, to produce a combinational time-frame-expanded netlist.

FIG. 4 illustrates, one implementation of the flow chart of FIG. 2A in which the programmed computer uses the combinational time-frame-expanded netlist generated by the method of FIG. 3, and the start state and target state specified by user, to create a conjunctive normal form (CNF) clause database.

FIG. 5 illustrates one implementation of the flow chart of FIG. 2A in which the programmed computer performs Boolean satisfiability analysis on the clause database generated by the method of FIG. 4 to find out whether or not the user-specified target state can be reached from the user-specified start state in the user-specified number of cycles, and in the process generates and saves for future use, one or more CNF clauses that are invariant.

FIG. 6 illustrates a sample circuit of the prior art that is analyzed by a computer that is programmed in accordance with the invention as described in detail below.

### DETAILED DESCRIPTION

In accordance with the invention, a computer is programmed to perform functional verification of a digital circuit by repeatedly analyzing a description of the circuit along with input data provided by the user, saving certain information (also called “learned information”) representing invariants learned during the analysis, and using the learned information during subsequent analyses.

In several embodiments, use of learned information as described herein enables the programmed computer to perform its subsequent analysis faster, at least by avoiding repetition of acts in a previous analysis that generated the learned information.

In several examples, the digital circuit that is described in a description to be analyzed by the programmed computer is a sequential digital circuit wherein one or more storage elements (such as registers) are intermixed with Boolean and/or arithmetic operators. In the case of a sequential digital circuit, several embodiments require the user to specify two or more analyses to be performed by the programmed computer, by identifying for each analysis the following: two states of the digital circuit, and a number of cycles of operation of the digital circuit. In these embodiments, the computer is programmed to analyze whether or not the digital circuit can enter one of the user-specified states (also called “target state”) in the user-specified number of cycles of operation (also called “analysis depth”), starting from another of the user-specified states (also called “start state”).

In some embodiments of the invention, the just-described start state can be selected to be any one of a number of states generated during simulation of the digital circuit being analyzed. Operation of the digital circuit is simulated using a commercially available logic simulator, such as the VCS simulator available from Synopsys. During each simulated cycle of operation, the simulator determines the logic values (0 or 1) of the registers of the simulated digital circuit (“simulation state”) and outputs them in a report, and the user simply picks one or more different states in the report to be used as start states.

Several embodiments use certain states from simulation that are automatically selected by a computer programmed to use one or more criteria of the type described in the commonly owned U.S. patent application, [Attorney Docket No. 0IN004 US] entitled “Selection of Initial States for Formal Verification” filed concurrently herewith by James Andrew Garrard Seawright et al. that is incorporated by reference herein in its entirety.

In some embodiments of the invention, a computer programmed to perform functional verification of a digital circuit in accordance with the invention searches for functional defects in the digital circuit by performing analysis to check if the digital circuit can enter one or more predetermined target states in a pre-determined number of cycles of operation, starting from any one of a set of two or more start states pre-determined using simulation.

Also, in several embodiments the user specifies target states, for example, using checkers that flag pre-determined defective behaviors, as described in U.S. Pat. No. 6,175,946 B1, “Method for automatically generating checkers for finding functional defects in a description of a circuit”, Tai An Ly, et al. that is incorporated by reference herein in its entirety. Depending on the embodiment, one or more target states may be identified (either by the user or pre-programmed into a computer) to be the one or more error state(s) of each checker (or a limited set of checkers) in any commonly available library of checkers.

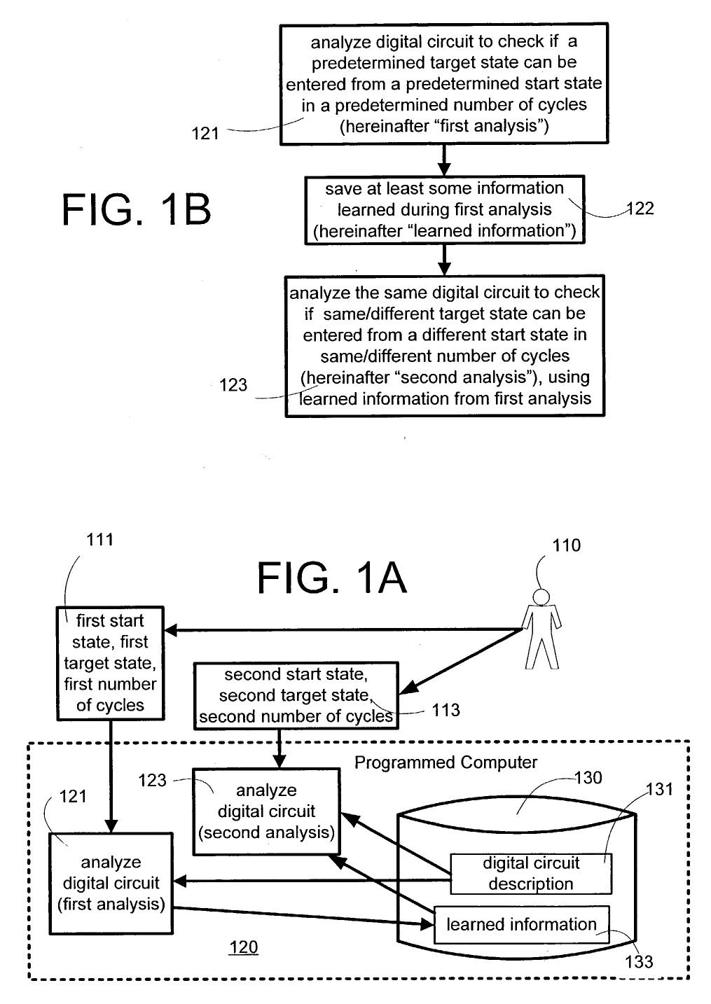

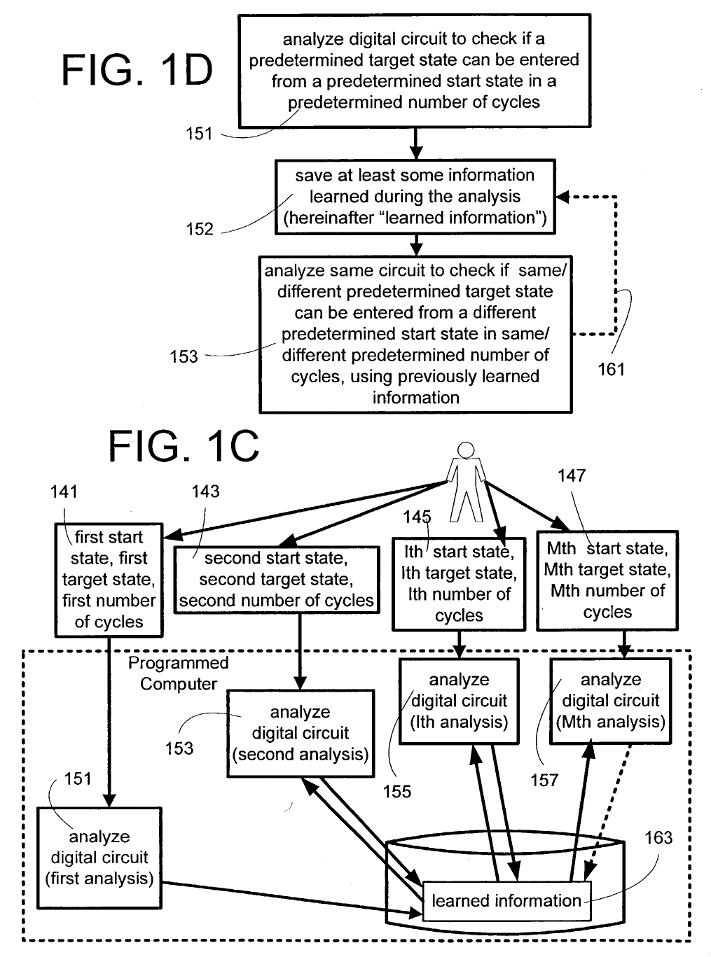

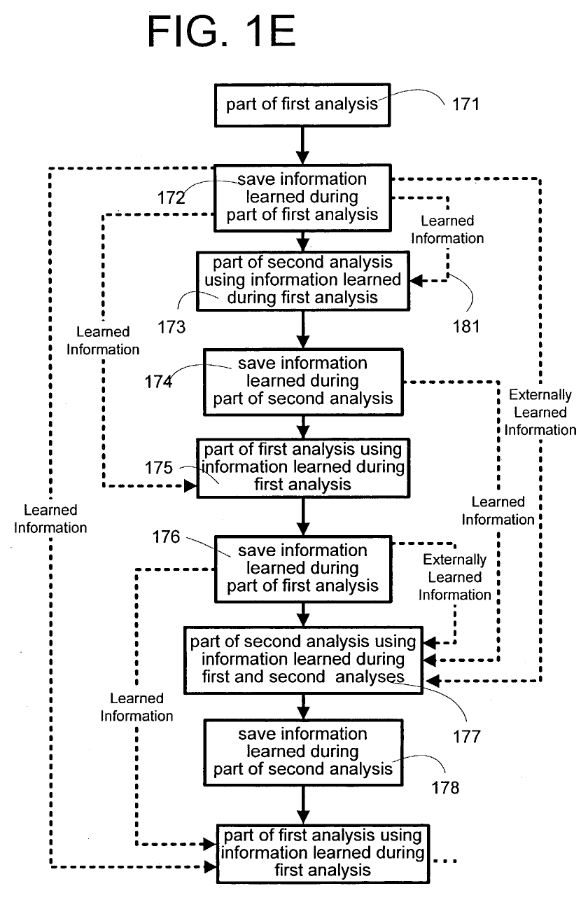

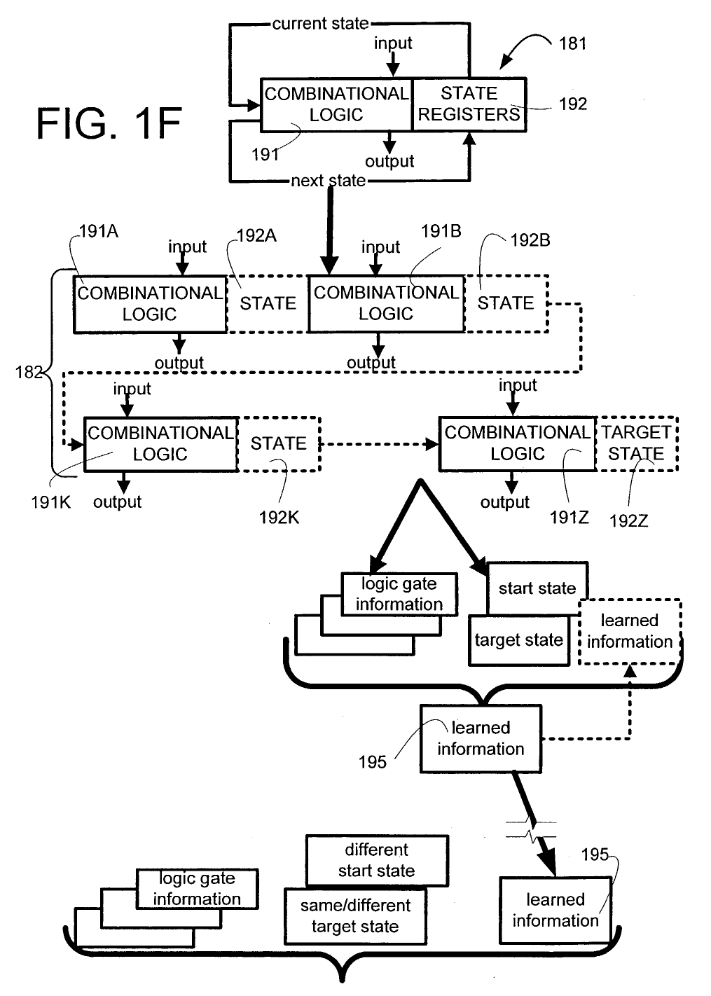

In certain embodiments illustrated in FIG. 1A, a programmed computer 120 receives from a user 110 two sets of input data, namely a first set 111 in which user 110 specifies a first start state, a first target state and a first number of cycles, and a second set 112 in which user 110 specifies a second start state different from the first start state, a second target state and a second number of cycles. Programmed computer 120 performs a first analysis 121 on the digital circuit in description 131 (FIG. 1A), to check if the digital circuit can enter the first target state in the first number of cycles of operation, starting from the first start state, as illustrated by act 121 in FIGS. 1A and 1B.

In certain embodiments, during this first analysis, programmed computer 120 either 1) determines that every possible sequence of input values applied to the inputs of the digital circuit in description 131 fails to cause the digital circuit to enter the first target state in the first number of cycles of operation (e.g. D1 cycles), starting from the first start state, or 2) determines a sequence of logic values to apply to the inputs of the digital circuit to cause the digital circuit to enter the first target state in D1 cycles of operation, starting from the first start state.

Next, in an act 122 (FIG. 1B), programmed computer 120 saves at least some information (hereinafter “learned information”) 133 (FIG. 1A) learned during the act 121 of analysis. This learned information 133 is being saved for later use, when performing another analysis, e.g. as described next. Thereafter, programmed computer 120 performs a second analysis 123 on the digital circuit description 131, using learned information 133 from first analysis 121, to check if the digital circuit can enter the second target state in the second number of cycles of operation, starting from the second start state, different from the first start state.

During this second analysis, programmed computer 120 again either 1) determines that every possible sequence of input values applied to the inputs of the digital circuit in description 131 fails to cause the digital circuit to enter the second target state in the second number of cycles (e.g. D2 cycles) of operation, starting from the second start state, or 2) determines a sequence of logic values to apply to the inputs of the digital circuit to cause the digital circuit to enter the second target state in D2 cycles of operation, starting from the second start state.

In certain embodiments, the process described above in reference to FIG. 1B is repeated (e.g. M times), as illustrated by branch 161 (FIG. 1D), which indicates that after act 153, act 152 is again performed, followed by act 153. Acts 152 and 153 are similar or identical to the corresponding acts described above, which are identified by reference numerals obtained by subtracting 30, i.e. acts 122 and 123. The just-described convention is applicable to several reference numerals, i.e. adding 30 to a reference numeral in FIGS. 1A and 1B yields a corresponding reference numeral in FIGS. 1C and 1D. Each additional analysis may benefit from information previously learned in any other analysis, e.g. analysis 155 may benefit from information learned in analyses 151 and 153 whereas analysis 157 may benefit from information learned in each of analyses 151, 153 and 157.

Although FIGS. 1B and 1D illustrate sequential processes during which one analysis is performed after completion of another analysis, in other embodiments two or more analyses of the type described herein can be performed concurrent with one another, even when one or more analyses use information learned in another analysis. For example, as illustrated in FIG. 1E, a part of a first analysis is performed as per act 171, followed by saving of the information learned during this part of the first analysis as per act 172. Thereafter, a part of a second analysis that uses the learned information from act 172 (as shown by the dashed arrow 181) is performed as per act 173, followed by saving of the information learned during this part of the second analysis as per act 174.

Furthermore, the first analysis has not completed in act 171, and therefore another part of the first analysis is performed in act 175, followed by saving of the information learned during this part of the first analysis as per act 176. Note that the first analysis part in act 175 uses information that was previously learned in the first analysis part in act 172.

At this stage, the second analysis has also not completed in act 173, and a part of the second analysis is therefore performed as per act 177, followed by saving of the information learned during this part of the second analysis as per act 178. Note that the second analysis part in act 177 uses information that was previously learned in the first analysis part in act 172, the second analysis part in act 174, and the first analysis part in act 176.

Although FIG. 1E illustrates performance of a number of parts of the first and second analyses interleaved among one another, for example by a single processor computer, in alternative embodiments, a computer having two or more processors may have one or more of the illustrated acts performed in a distributed manner. For example, a two processor computer may use one processor for each analysis. Moreover, depending on the embodiment, a processor performing all parts of the first analysis need not wait for anything from another processor performing all parts of the second analysis, in which case act 173 may be performed simultaneously with act 175. Also, in some embodiments multiple different analyses may share information learned from one another, and such embodiments may maintain learned information in a shared resource to be commonly accessed when performing each of numerous analyses. Numerous such modifications and adaptations of such embodiments will be apparent to the skilled artisan in view of the disclosure.

In several embodiments, programmed computer 120 performs time-frame expansion of the digital circuit 181 (FIG. 1F) described in description 131, to produce a combinational time-frame-expanded digital circuit 182. In FIG. 1F, for convenience, digital circuit 181 that is to be analyzed is illustrated as including combinational logic 191 and storage elements 192 that hold state information (also referred to as “state registers”). Time-frame expansion of digital circuit 181 by C cycles results in a combinational digital circuit 182 that includes C copies of combinational logic 191 that are individually labeled as 191A-191Z. Outputs of the combinational time-frame-expanded digital circuit 182 mimic the registers of the corresponding digital circuit 181 after C cycles of operation.

Next, the time-frame-expanded circuit 182 (FIG. 1F) is used by programmed computer 120 to check if digital circuit 181 can enter the target state in the number of cycles of operation specified by the user, starting from the start state. In several embodiments, programmed computer 120 expresses a satisfiability problem, and then solves the satisfiability problem in the normal manner. However, in other embodiments, programmed computer 120 may express the problem of causing digital circuit 181 to transition between the start state and the target state as different type of problem, such as a circuit automatic test-pattern generation (ATPG) problem. In such other embodiments, computer 120 is programmed appropriately to solve the circuit ATPG problem in any manner well known to the skilled artisan in view of this disclosure.

Regardless of the type of problem expressed, computer 120, when programmed in accordance with the invention, learns during the problem solving process, certain information related to digital circuit 181 that can be used during another analysis of the same digital circuit 181 (“learned invariants”). Learned invariants remain true even if a different start state is used by computer 120, when programmed in accordance with the invention, in a subsequent analysis of the same digital circuit 181, to check if the digital circuit 181 can enter the same or different target state in the same or different analysis depth number of cycles of operation, starting from a different start state.

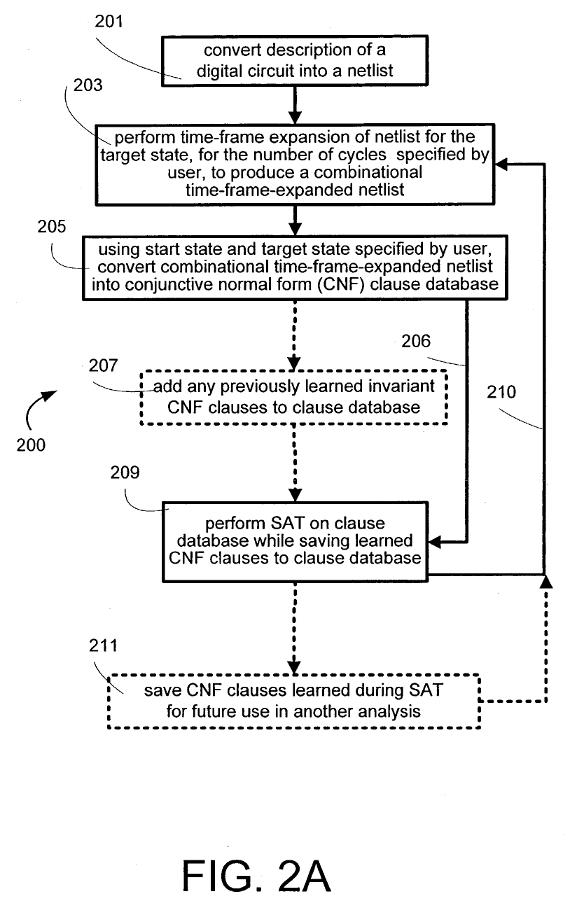

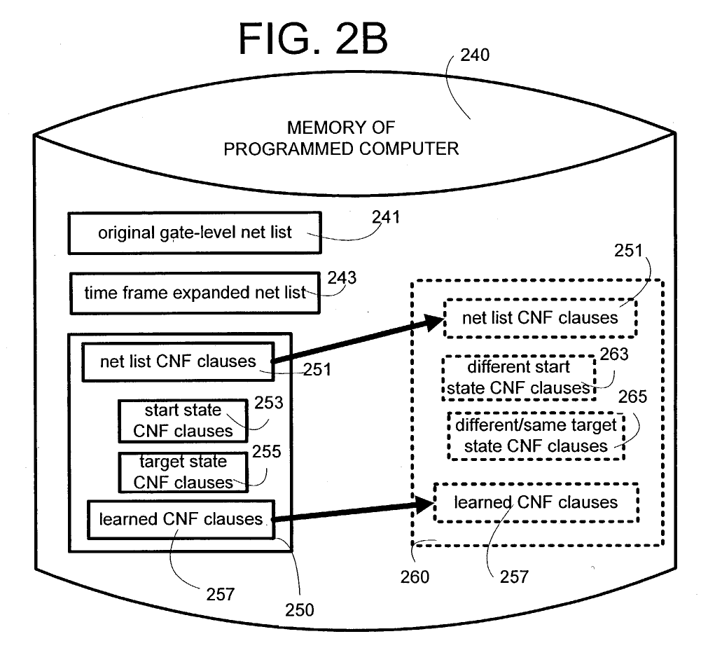

As noted above, in a number of embodiments, computer 120 is programmed to solve a satisfiability (“SAT”) problem, and several embodiments perform the acts illustrated in FIG. 2A. Such a computer 120, when programmed by software (hereinafter “functional verification tool”) that implements method 200 (FIG. 2A), performs functional verification of a digital circuit (also called “circuit-under-verification”) by analyzing a description of the circuit together with pre-determined input data.

Hereinafter, all references to a functional verification tool are intended to mean an appropriately programmed computer 120 that performs method 200. Such a programmed computer 120 can be, for example, a workstation computer that includes memory (e.g., 512 MB of random access memory) and central processing unit (CPU) of the type well known to a person skilled in the art of electronic design automation (EDA).

Moreover, simulation of the functional behavior of a digital circuit 181 is sometimes described herein as simply simulation of a circuit or simulation. Such simulation can be performed by programming the computer 120 with simulation software, such as Verilog-XL available from Cadence Design Systems, San Jose, Calif., and VCS available from Synopsys, Mountain View, Calif.

In some embodiments of the invention, the functional verification tool performs functional verification of a circuit-under-verification comprising registers, AND, OR, and NOT logic gates and inputs. The circuit-under-verification is represented in an input file as a netlist indicating the type, output node name and input node names of each logic gate and register in the circuit. For example the element “AND (N1,N2,N3)” of a netlist represents a single AND logic gate with a single output node named “N1”, and inputs connected to other nodes named “N2” and “N3”. It will be apparent to a person skilled in the art of EDA in view of this disclosure that any digital circuit can be represented using a netlist containing only registers, AND, OR and NOT logic gates and inputs. Also, various alternative formats for representing a digital circuit as a netlist containing registers, AND, OR and NOT logic gates and inputs will be apparent to a person skilled in the art of EDA in view of this disclosure.

In several embodiments of the invention, the user specifies target states representing pre-determined defective behaviors of the circuit-under-verification. Each target state is characterized by a single target state register being logic value 1. (Logic value 1 is also called “asserted” or “true” and logic value 0 is also called “de-asserted” or “false”.) Regardless of the logic values of all other registers, the circuit-under-verification is considered to be in the target state if the target state register is asserted and the circuit-under-verification is considered not to be in the target state if the target state register is not asserted.

Various alternative forms of target-state specification will be apparent to a person skilled in the art of EDA in view of this disclosure, including forms in which, for the circuit-under-verification to be considered to be in the target state, a subset of registers must be asserted and another subset of registers must be de-asserted and still another subset of registers may be either asserted or de-asserted (“don't care”).

In several embodiments of the invention, the user specifies start states of the circuit-under-verification. Each start state is characterized by a subset of the state registers being de-asserted, a subset of the state registers being asserted, and all other state registers being don't care. Various alternative forms of start-state specification will be apparent to a person skilled in the art of EDA in view of this disclosure, including forms in which every state register is specified as being either de-asserted or asserted.

It will be apparent to a person skilled in the art of EDA in view of this disclosure that the circuit-under-verification may include circuitry to detect the pre-determined defective behaviors. Also, it will be apparent to a person skilled in the art of EDA in view of this disclosure in view of this disclosure that the target states may represent pre-determined behaviors of the circuit-under-verification that are not defective behaviors, for example, the target states may represent corner-case behaviors of the circuit-under-verification which are unusual but not defective, or the target states may represent other states of the circuit-under-verification which are of interest to the user. Also, it will be apparent to a person skilled in the art of EDA in view of this disclosure that the first and second target states may be identical or the first and second target states may be different.

Computer 120 of some embodiments is programmed to receive as input a description of the circuit-under-verification in the format discussed above, and also receive as input at least one target state and at least two different start states in the format discussed above, so that at least a pair of analyses need to be performed. Referring to FIG. 2A, in act 201, programmed computer 120 represents the digital circuit 181 as a gate-level netlist 241 illustrated in FIG. 2B (for example, a gate-level netlist produced by a commercially available logic-synthesis tool, such as the Design Compiler product provided by Synopsys, from a Verilog or VHDL description of the digital circuit).

Next, in act 203 (FIG. 2A), programmed computer 120 performs a time-frame expansion for the target state register of the original gate-level netlist 241 for a number of cycles that have been specified by the user, to produce a combinational time-frame-expanded netlist 243 (FIG. 2B). Thereafter, in act 205 (FIG. 2A), programmed computer 120 uses the combinational time-frame-expanded netlist 243, and the user-specified start and target states, to create a conjunctive normal form (CNF) clause database 250. As is well known to the skilled artisan, the CNF formula of a combinational circuit is the conjunction of the CNF formulae of all the gates of the circuit, where the CNF formula of each gate denotes the valid input-output assignments to the gate.

At this stage, if this is the first iteration for the digital circuit 181, clause database 250 typically includes CNF clauses 251 that are based on the netlist, and CNF clauses 253 and 255 that are respectively based on the start and target states. Moreover, at this stage, since this is the first iteration for the digital circuit 181, computer 120 goes from act 205 directly to act 209 to implement a SAT solver (e.g., based on the GRASP algorithm), as illustrated by branch 206 in FIG. 2A.

In some embodiments illustrated in FIGS. 2A and 2B, computer 120 is programmed to perform act 209 by implementing a SAT solver. One implementation of such a SAT solver that performs Boolean constraint propagation, diagnoses conflicts, and learns new CNF clauses from the conflicts. In other implementations, new CNF clauses may be learned in any other manner well known to a person skilled in the art of SAT solvers, for example, new CNF clauses may be learned by using “recursive learning”, described in “Recursive Learning: A new implication technique for efficient solutions to CAD-problems: test, verification and optimization”, by W. Kunz and D. Pradhan, Transactions on Computer-Aided Design, Vol. 13, No. 9, pp. 1143-1158, September 1994, which is incorporated by reference herein in its entirety.

Moreover, as would be apparent to the skilled artisan in view of the disclosure, instead of using CNF clauses in a method of the type illustrated in FIG. 2A, other embodiments of the invention may use other formats of representation of combinational circuit elements for holding information learned by a SAT solver. Therefore, in such embodiments learned information can take the form of a learned netlist, learned data structures and/or learned code in a programming language such as “C”, “C++” or “Java” as described elsewhere herein.

Therefore, during act 209 (FIG. 2A), computer 120 is programmed to learn invariants related to the digital circuit, in the form of CNF clauses 257 (FIG. 2B) in clause database 250. The newly-learned CNF clauses 257 describe properties related to digital circuit 181, and for this reason they are invariant across multiple analyses. In several embodiments, after performance of act 209, programmed computer 120 simply returns to act 203 (described above), to perform one or more additional analyses, using the same clause database 250 (now containing CNF clauses 257) that was used in act 209.

However, in alternative embodiments, after performance of act 209, another act 211 is performed wherein the newly-learned CNF clauses 257 saved in a repository (also called “archive”) different from the clause database (in addition to being saved in clause database 250). In such embodiments, on performing act 205 two or more times, computer 120 performs act 207 in which all previously learned CNF clauses 257 (FIG. 2B) from an archive are added to clause database 260 to which the SAT solver is applied subsequently in act 209. Furthermore, although in some embodiments act 207 is performed automatically, in an alternative embodiment act 207 is performed manually, as illustrated by the listing of “externally learned clauses” at the end of each of Appendices A8 and A12.

As noted above, just as programmed computer 120 learns and stores CNF clauses during a first analysis using a first start state, it learns and stores additional clauses during the second analysis using a second start state. The programmed computer 120 uses the additional clauses learned during both the first and second analyses to simplify a third and other analyses to check if the digital circuit can enter any of a set of target states in a pre-determined number of cycles of operation, starting from any of a set of start states.

The method of storing clauses learned when applying a SAT solver using a first start state and re-using the learned clauses during SAT analyses using a second, third and additional start states reduces the number of acts required for SAT solver and reduces the total time required for the SAT solver to complete using all start states in a set of start states. Therefore, the method of several embodiments reduces the time required for a programmed computer to automatically check if the digital circuit can enter a state indicative of a pre-determined defective behavior, starting from any of a set of start states, and reduces the time required for functional verification of the digital circuit.

In several embodiments, programmed computer 120 receives as input a description of the digital circuit 181, specifications of a first state, a second state, a third state and a fourth state of the digital circuit 181, wherein the fourth state is different from the second state, and two numbers D1 and D2. The programmed computer 120 performs a first analysis to determine whether at least one sequence of logic values applied to the inputs of the digital circuit causes the digital circuit to enter the first state in D1 cycles of operation, starting from the second state. During the first analysis, the programmed computer learns invariants related to the digital circuit and stores the learned invariants for later use. The programmed computer performs a second analysis to determine whether at least one sequence of logic values applied to the inputs of the digital circuit causes the digital circuit to enter the third state in D2 cycles of operation, starting from the fourth state. The programmed computer of several embodiments uses the learned invariants to simplify the second analysis.

In some embodiments of the invention, the user simulates the circuit-under-verification using a commercially available simulator and a simulation testbench that applies logic values to all inputs of the simulated circuit during each simulated cycle of operation. Starting from a reset state or a user-specified state of the circuit-under-verification, for each simulated cycle, the simulator determines the logic values of all registers in the current cycle based on the logic values of the registers and inputs in the preceding cycle. After each cycle of simulation, the simulator outputs the simulated state of the circuit-under-verification (“simulation state”), comprising the logic values of all registers, to an output file. The user then selects two or more different simulation states to be used in the analysis as start states.

Various alternative methods of determining states of the circuit-under-verification to be used as start states in the analysis will be apparent to a person skilled in the art of EDA in view of this disclosure. For example, the user may manually specify the start states without using a simulator. Various methods of selecting simulation states for analyses will be apparent to a person skilled in the art of EDA in view of this disclosure, including selecting sequential simulation states, selecting simulation states separated by a fixed number of cycles of operation greater than one cycle, randomly selecting simulation states, and selecting simulation states according to a simulation coverage metric such as corner-case coverage, and selecting simulation states according to the method described in the commonly owned U.S. patent application, [Attorney Docket No. 0IN004 US] entitled “Selection of Initial States for Formal Verification” filed concurrently herewith by James Andrew Garrard Seawright et al. that is incorporated by reference herein in its entirety.

In some embodiments of the invention, the user delivers files containing a netlist describing the circuit-under-verification and specifying the target states, the start states, and the analysis depths to the functional verification tool for analysis.

In some embodiments of the invention, the functional verification tool performs time-frame expansion of the netlist of the circuit-under-verification using the procedure shown below. Time-frame-expansion may be done by any well-known prior-art method, and many variants of this time-frame expansion procedure will be apparent to a person skilled in the art of EDA in view of this disclosure.

In some embodiments of the invention, digital circuit 181 is combinational (i.e., contains no state registers). It will be apparent to a person skilled in the art of EDA in view of this disclosure that, in case digital circuit 181 is combinational, the netlist of digital circuit 181 can be used directly in lieu of the time-frame-expanded netlist, without performing the time-frame-expansion procedure.

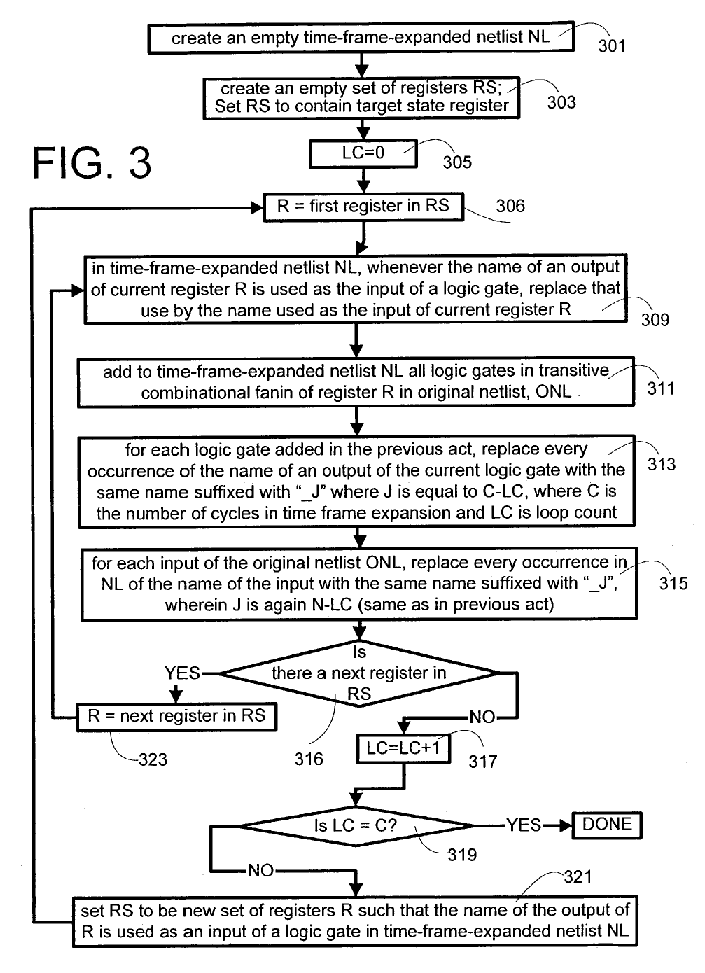

The following is an exemplary procedure for C-cycle time-frame expansion for a selected target state register of a digital circuit represented as a netlist of logic gates, registers and inputs:
1) Let ONL be the original netlist. Create an empty time-frame-expanded netlist, NL as illustrated by act 301 (FIG. 3). Create an empty set of registers, RS, as illustrated by act 303. Set loop counter LC to the value 0, as illustrated by act 305.
2) Set RS to be the set containing only the target state register from ONL, as illustrated by act 303.
3) For each register R in RS, as illustrated by acts 306, 316 and 323 (in act 306, R is set to the first register in RS, act 316 checks if there is a next register in RS, act 323 sets R to be the next register in RS, and returns to act 309):
a) In NL, wherever the name of the output node of R is used as the input of a logic gate G, replace that use by the name used as the input of R, as illustrated by act 309.
b) Add to NL all the logic gates in the transitive combinational fanin of R in the original netlist, as illustrated by act 311. (The transitive combinational fanin of R is all logic gates in the complete fanin of R back to registers or inputs of the digital circuit.) In some implementations, the following sub-acts are performed within act 311:
   i) Create a set of logic gates, GS, initially containing the logic gate G such that the name of the output node of G is used as the input of R.
   ii) Repeat the following until no new logic gates are added to GS:
      For each logic gate G1 in GS:
         For each logic gate G2 in ONL such that the name of the output node of G2 is used as the input of G1, if G2 is not already in GS, then add G2 to GS.
   iii) Add all logic gates in GS to NL.
      In other implementations, alternatives to the above-discussed sub-acts may be performed within act 311.
c) For each logic gate added to NL in act 311, replace every occurrence in NL of the name of the logic gate output node with the same name suffixed with “_J”, where J is equal to C-LC, as illustrated by act 313.
d) For each input of the original netlist, replace every occurrence in NL of the name of the input with the same name suffixed with “_J”, where J is equal to C-LC, as illustrated by act 315.
4) Set LC to the value LC+1, as illustrated by act 317. If LC is equal to C (as checked in act 319), then done (NL contains the C-cycle time-frame-expanded netlist).
   Otherwise:
a) Set RS to be the set of registers R such that the name of the output node of R is used as an input of a logic gate in NL, as,illustrated by act 321.
b) Go to act 306.

After time-frame expansion using this procedure, the resulting time-frame-expanded netlist represents a combinational circuit (the “time-frame-expanded circuit”). The time-frame-expanded circuit corresponds to C cycles of operation of the original circuit, as follows: For each input “I” of the original circuit, input “I_{—}1” of the time-frame-expanded netlist corresponds to input “I” in the first cycle of operation of the circuit, input “I_{—}2” of the time-frame-expanded netlist corresponds to input “I” in the second cycle of operation of the circuit, etc.

Also, the logic-gate output in the time-frame-expanded netlist corresponding to the target state register after C cycles of operation has the name “Din” suffixed with “_” and the integer C, where “Din” is the name used as the data input of the target state register in the original netlist. Also, each input of each logic gate in the time-frame-expanded netlist that uses the same name as the output of a register in the original circuit corresponds to said register in the first cycle of operation of the original circuit, starting from the start state being analyzed.

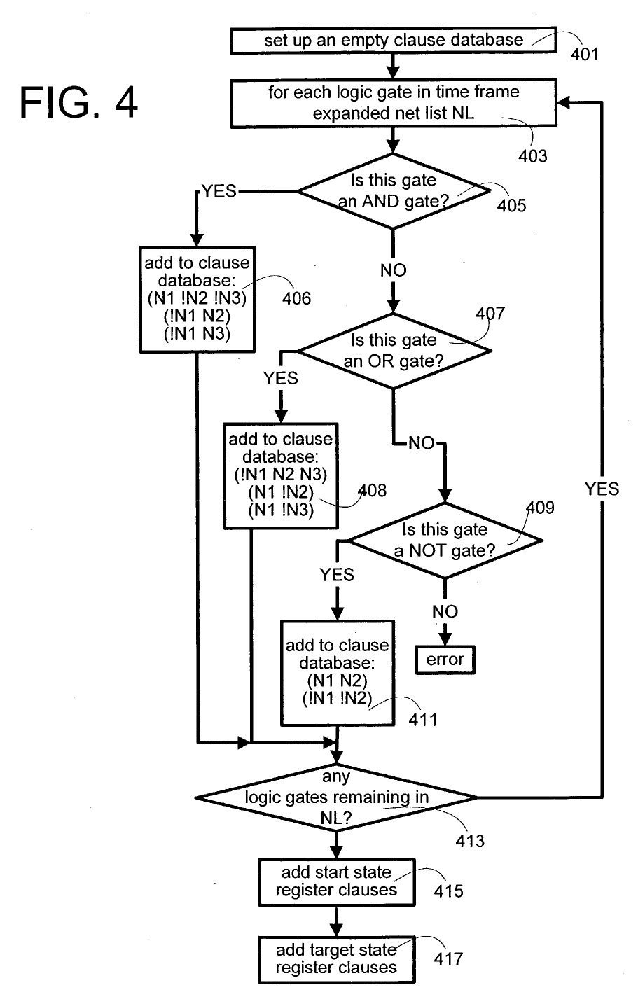

In some embodiments of the invention, the functional verification tool converts the time-frame-expanded netlist to a CNF (conjunctive normal form) representation, as illustrated in FIG. 4. CNF representation is well known to a person skilled in the art of EDA in view of this disclosure. Briefly, a CNF clause “(T1 T2 . . . Ti)” represents the Boolean “or” of the logic values of the terms T1, T2, . . . Ti in the clause. Each term itself is either of the form “N” or “!N”, where “N” is the name of a Boolean variable. The form “N” represents the logic value of the variable N, and the form “!N” represents the complement of the logic value of the variable N. One or more CNF clauses concatenated together form a CNF formula representing the Boolean “and” of all the results of the Boolean “or” operations represented by the individual CNF clauses appearing in the formula.

Any logic gate can be represented as an equivalent CNF formula. In particular, the logic gates AND, OR and NOT can be represented by the equivalent CNF formulae shown below:

| Logic Gate | Equivalent CNF Formula |
|---|---|
| AND (N1 N2 N3) | (N1 !N2 !N3) (!N1 N2) (!N1 N3) |
| OR (N1 N2 N3) | (!N1 N2 N3) (N1 !N2) (N1 !N3) |
| NOT (N1 N2) | (N1 N2) (!N1 !N2) |

Furthermore, any netlist containing logic gates can be represented as an equivalent CNF formula by replacing each logic gate in the netlist by its equivalent CNF formula. Therefore, to convert the time-frame-expanded netlist to an equivalent CNF formula, the functional verification tool replaces each logic gate in the time-frame-expanded netlist by its equivalent CNF formula, shown above, to form a new CNF formula (hereinafter called the “time-frame-expanded CNF formula”).

Some embodiments generate a clause database from a time-frame-expanded circuit by performing several acts illustrated in FIG. 4. Specifically, such embodiments set up an empty clause database as per act 401. Next, a loop is performed for each logic gate in time frame expanded net list NL, as per act 403. Acts 405-409 and 411 that are described below are performed within this loop, followed by act 413 to check if any logic gates remain in NL, and if so, returning to act 403. If no logic gates remain in NL, then clauses for start and target states are added as per the respective acts 415 and 417.

Within the above described loop, a check is made if the current gate is an AND gate (in act 405) and if so, the clause (N1 !N2 !N3)(!N1 N2)(!N1 N3) is added to the clause database (as per act 406). Note that in act 406, N2 and N3 denote the inputs to the AND gate and N1 denotes the output. After performing act 406, control transfers to act 413 (described above). If the answer is no in act 405, a check is made if the current gate is an OR gate (in act 407) and if so, the clause (!N1 N2 N3)(N1 !N2)(N1 !N3) is added to the clause database and control transfers to act 413. If the gate is neither OR gate nor AND gate, then it is checked in act 409 for being a NOT gate, and if so, the clause (N1 N2)(!N1 !N2) is added to the clause database and control transfers to act 413. If the answer is no in act 409, an error is printed, because these embodiments do not handle any devices other than AND, OR and NOT gates.

In some embodiments of the invention, to perform a specific analysis (for example, a first analysis, a second analysis, or a third analysis) to determine whether at least one sequence of logic values applied to inputs of the circuit-under-verification causes the circuit to enter a specific target state (for example, a first target state, a second target state, or a third target state) in D cycles of operation, starting from a specific start state (for example, a first start state, a second start state, or a third start state), the functional verification tool creates a CNF formula (hereinafter called “target CNF formula”) as follows.

Using the netlist of the circuit-under-verification as input, the functional verification tool creates a D-cycle time-frame-expanded netlist for the target state register, as shown above. Then, the functional verification tool converts the D-cycle time-frame-expanded netlist to a time-frame-expanded CNF formula, as shown above. Then, the functional verification tool concatenates the clause “(T)” to the resulting CNF formula, where “T” is the name of the output of the time-frame-expanded netlist corresponding to the target state register. Then, for each register R of the circuit-under-verification, the functional verification tool does the following: if R is asserted in the specification of the specific start state, the functional verification tool concatenates the CNF clause “(R)” to the resulting formula, otherwise, if R is de-asserted in the specification of the specific start state, the functional verification tool concatenates the CNF clause “(!R)” to the resulting formula, otherwise, R is don't care in the specification of the specific start state and the functional verification tool concatenates neither “(R)” nor “(!R)” to the resulting formula.

In some embodiments of the invention, the functional verification tool incorporates a SAT program implementing a prior-art CNF-based SAT algorithm such as GRASP. The SAT program receives as input a target CNF formula created as described above, using a specific target state, a specific start state, and a specific analysis depth D. The functional verification tool uses the SAT program to perform analysis to determine whether at least one assignment of logic values to the variables of the target CNF formula causes the target CNF formula to evaluate to true. Such an assignment of logic values to the variables of the target CNF formula (a “satisfying assignment”) includes assignments of logic values to all inputs of the time-frame-expanded circuit. (“Don't care” variables of the target CNF formula are considered to be assigned to logic value 0 in the satisfying assignment.)

A method of some embodiments described herein to construct the target CNF formula guarantees that, in any satisfying assignment, the inputs of the time-frame-expanded netlist corresponding to registers in the circuit-under-verification must be assigned the logic values specified for those registers in the specific start state and the target output of the time-frame-expanded netlist must be assigned the logic value 1. Therefore, any satisfying assignment corresponds to a sequence of logic values to apply to inputs of the circuit-under-verification to cause the circuit to enter the specific target state in D cycles of operation, starting from the specific start state. It follows that in such embodiments the acts performed by the SAT program determine whether at least one sequence of logic values applied to the inputs of the circuit-under-verification causes the circuit to enter the specific target state in D cycles of operation, starting from the specific start state. Similarly, it follows that in such embodiments the acts performed by the SAT program check if the circuit can enter the specific target state in D cycles of operation, starting from the specific start state.

The SAT problem has been extensively studied and various types of CNF-based SAT algorithms and methods will be apparent to a person skilled in the art of EDA in view of this disclosure. One example of a SAT program (also “example program”) is shown in Appendix A14. The example SAT program is written in the “C++” language and implements a SAT algorithm similar to GRASP. A number of functions that are used in the example SAT program are described at the end of this description, just before the claims.

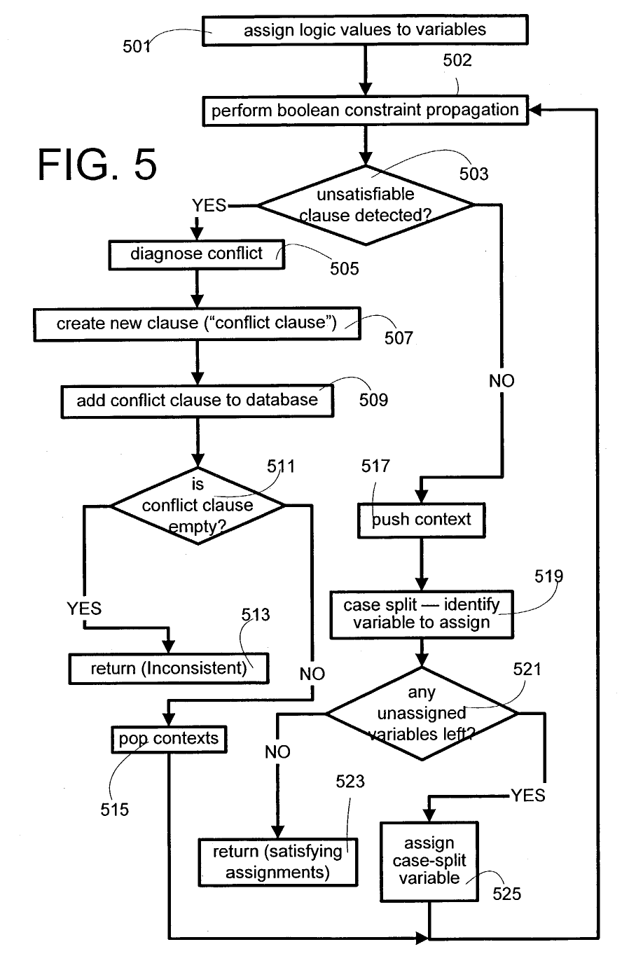

In some embodiments of the invention, a SAT program (for example, the example program) implementing a CNF-based SAT algorithm stores all the clauses of the target CNF formula in a clause database in the memory of the programmed computer. The SAT program performs acts, as described below just before the claims, including assigning logic values to variables of the target CNF formula as per act 501 (FIG. 5), performing Boolean constraint propagation (“BCP”) as per act 502, checking if an unsatisfiable clause is detected as per act 503, diagnosing conflicts as per act 505, and learning CNF clauses as per act 507. Each time the SAT program diagnoses a conflict, the SAT program learns a single CNF clause representing an invariant related to the digital circuit. The SAT program adds the learned clause to the clause database as per act 509 and uses the learned clause throughout the subsequent acts by performing BCP using all the clauses in the database. The SAT program then checks if the conflict clause is empty as per act 511, and returns inconsistent if true, as per act 513. If false in act 511, contexts are popped as per act 515.

In act 503, if there is no unsatisfiable clause, the context is pushed, as per act 517, and a case split is performed, identifying a variable to assign as per act 519, and a check is made for any unassigned variables being left as per act 521. If “no” in act 521, then the satisfying assignment is returned in act 523, but if “yes” in act 521, there is an assignment of the case split variable in act 525. Acts 501 et seq. are repeated after each of acts 515 and 525.

Various alternative methods of learning invariants related to the digital circuit will be apparent to person skilled in the art of EDA in view of this disclosure, including “recursive learning”. Various alternative methods of storing the learned clauses will be apparent to a person skilled in the art of EDA in view of this disclosure, including converting the learned clauses into equivalent logic gates (“learned logic gates”) and storing the learned logic gates in the memory of the programmed computer; converting the learned clauses into equivalent “C”, “C++” or “Java” code (“learned code”) and storing the learned code in the memory of the programmed computer; converting the learned clauses into a data-structure to be interpreted by a “C”, “C++” or “Java” program (“learned data structure”) and storing the learned data-structure in the memory of the programmed computer; and storing any of the equivalent forms described above on a peripheral device accessible by the programmed computer. Various alternative methods of performing the other analysis acts described above will be apparent to a person skilled in the art of EDA in view of this disclosure. In particular, prior-art SAT references cited in the “Background” section, above, describe alternative methods for performing these analysis acts.

In some embodiments of the invention, the functional verification tool performing functional verification of the circuit-under-verification performs analysis of the netlist of the circuit-under-verification. The functional verification tool uses a SAT program implementing a CNF-based SAT algorithm to perform a first analysis using a user-specified first target state, a first start state determined during simulation of the circuit-under-verification, and a user-specified first analysis depth D1, to determine whether at least one sequence of logic values applied to the inputs of the circuit-under-verification causes the circuit to enter the first target state in D1 cycles of operation, starting from the first start state. The functional verification tool stores invariants learned during the first analysis (“first learned invariants”) as CNF clauses. The functional verification tool uses the SAT program to perform a second analysis using a user-specified second target state, a second start state different from the first start state, determined during simulation of the circuit-under-verification, and a user-specified second analysis depth D2, to determine whether at least one sequence of logic values applied to the inputs of the circuit-under-verification causes the circuit to enter the second target state in D2 cycles of operation, starting from the second start state.

The SAT program of some embodiments uses the first learned invariants to simplify the second analysis by avoiding repeating analysis acts performed during the first analysis. The functional verification tool stores invariants learned during the second analysis (“second learned invariants”) as CNF clauses. The functional verification tool uses the SAT program to perform a third analysis using a user-specified third target state, a third start state different from both the first start state and the second start state, determined during simulation of the circuit-under-verification, and a user-specified third analysis depth D3, to determine whether at least one sequence of logic values applied to the inputs of the circuit-under-verification causes the circuit to enter the third target state in D3 cycles of operation, starting from the third start state. The SAT program uses the first learned invariants and the second learned invariants to simplify the third analysis by avoiding repeating analysis acts performed during the first analysis and the second analysis.

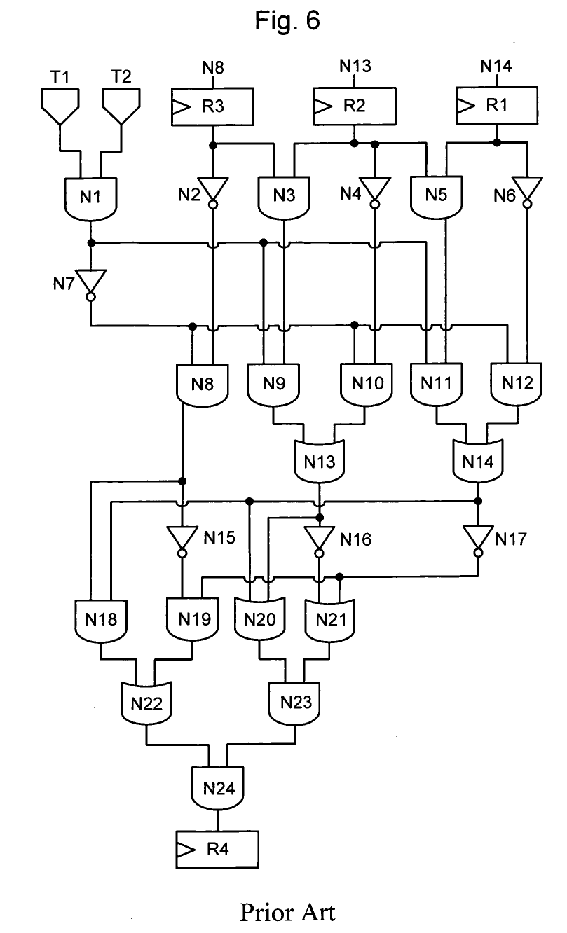

The method of one embodiment is illustrated herein using a small example: The circuit-under-verification comprises four registers R1-R4, 24 logic gates N1-N24 and two inputs I1-I2 (FIG. 6). The netlist of the circuit-under-verification is shown in Appendix A1. The first target state, the second target state and the third target state are all characterized by R4 being asserted, and R1, R2 and R3 being don't care. The first start state is characterized by R3 being asserted, R1 and R2 being de-asserted, and R4 being don't care; the second start state, different from the first start state, is characterized by R1, R2 and R3 being de-asserted, and R4 being don't care; and the third start state, different from both the first and second start states, is characterized by R1 being asserted, R2 and R3 being de-asserted, and R4 being don't care. The first analysis depth, the second analysis depth and the third analysis depth are all equal to two cycles of operation of the circuit-under-verification.

In the small example, the analysis depth is equal to two and the target state register is R4 for all of the first, second and third target states, therefore the functional verification tool performs two-cycle time-frame expansion for register R4 of the netlist of the circuit-under-verification according to the procedure above, producing the time-frame-expanded netlist shown in Appendix A2. (The CNF formula corresponding to the time-frame-expanded netlist is shown in Appendix A3.) Inputs I1_1 and I1_2 of the time-frame-expanded netlist correspond to input I1 of the circuit-under-verification in the first and second cycles of operation, respectively. Inputs I2_1 and I2_2 of the time-frame-expanded netlist correspond to input I2 of the circuit-under-verification in the first and second cycles of operation, respectively. Output N24_2 of the time-frame-expanded netlist corresponds to target state register R4 of the circuit-under-verification after two cycles of operation. Inputs R1-R3 of the time-frame-expanded netlist correspond to registers R1-R3, respectively, of the circuit-under-verification in the specific start state to be used in the specific analysis.

For illustrative purposes, the first, second and third analysis depths of the small example are identical and the first, second and third target states of the small example are identical. As a result, the time-frame-expanded netlists used in the first, second and third analyses are identical. It will be apparent to a person skilled in the art of EDA in view of this disclosure that in other examples using the method of certain embodiments of the invention the first, second and third analysis depths may not be identical and that the first, second and third target states may not be identical, and that in such examples the target time-frame-expanded netlists used in the first, second and third analyses may not be identical.

The example program receives as input a file specifying the two-cycle time-frame-expanded netlist for the target register of the circuit-under-verification, a start state, the name of the target output, and (optionally) learned clauses from a previous analysis (“externally learned clauses”). The example program creates a target CNF formula as described above, using the time-frame-expanded netlist, the start state and the target output. The example program concatenates the externally learned clauses, if any, to the target CNF formula. The example program then uses a SAT algorithm similar to GRASP to perform a series of analysis acts to determine whether at least one assignment of logic values to variables of the target CNF formula causes the CNF formula to evaluate to true.

In case the example program determines that every possible assignment of logic values to variables of the target CNF formula fails to cause the CNF formula to evaluate to true, it prints “Inconsistent” and exits. In case the example program finds an assignment of logic values to the variables of the target CNF formula to cause the CNF formula to evaluate to true, it prints “Satisfiable” and reports the assignment of logic values to the variables corresponding to inputs of the time-frame-expanded circuit, which, in turn, correspond to logic values to apply to the inputs of the circuit-under-verification to cause the circuit-under-verification to enter the target state in two cycles of operation, starting from the start state.

In a first analysis of the circuit of the small example, the example program receives as input the file shown in Appendix A4. The start state is characterized by R3 being asserted, R1 and R2 being de-asserted, and R4 being don't care. The target output is N24_2. The program performs a series of analysis acts, producing the output shown in Appendix A5. Specifically, the program performs the following analysis acts:
1. Performs Boolean constraint propagation (indicated as “Propagate”).
2. Pushes a new context (indicated as “Push”).
3. Case splits on node N1_1 (indicated as “CaseSplit”) and assigns node N1_1 to the logic value 1.
4. Performs Boolean constraint propagation.
5. Pushes a new context.
6. Case splits on node N1_2 and assigns node N1_2 to the logic value 1.
7. Performs Boolean constraint propagation.
8. Finds that the assigned values cause a conflict, diagnoses the cause of the conflict, learns a new clause “(!N20_{—}2 N11_{—}2 N9_{—}2 !N1_{—}2)” and adds the new clause to the clause database (indicated as “Diagnose”).
9. Pops contexts (indicated as “Pop”).
10. Propagates the values from the previous context using the newly added clause.
11. Finds that the assigned values cause a conflict, diagnoses the conflict, learns another new clause “(!N21_{—}2 !N20_{—}2 N9_{—}2 N9_{—}1 N11_{—}1 N1_{—}1)” and adds the new clause to the clause database.
12. Pops contexts.
13. Propagates the values from the previous context using the newly added clause.
14. Finds that the assigned values cause a conflict and diagnoses the conflict to find an empty clause.
15. Determines that there is no satisfying assignment (indicated as “Inconsistent”) and exits.

By determining that there is no satisfying assignment of the variables of the target CNF formula, the example program has also determined that every possible sequence of logic values applied to the inputs of the circuit-under-verification fails to cause R4 of the circuit to be asserted (the target state) in two cycles of operation (the analysis depth D), starting from a state in which R3 is asserted and R1 and R2 are de-asserted (the first start state).

Importantly, the example program learns the following clauses during the first analysis:
1. (!N20_2 N11_2 N9_2 !N1_2), and
2. (!N21_2 !N20_2 N9_2 N9_1 N11 !N1_1)

Each learned clause represents a learned invariant related to the circuit-under-verification and can be used in other analyses of the circuit using different start states.

The first learned clause shown above represents an invariant related to the circuit-under-verification as follows: When the example circuit-under-verification shown in FIG. 6 operates, starting from any start state, at least one of the following statements must be true:
1. The output of logic gate N20 in the second cycle of operation is de-asserted.
2. The output of logic gate N11 in the second cycle of operation is asserted.
3. The output of logic gate N9 in the second cycle of operation is asserted.
4. The output of logic gate N1 in the second cycle of operation is de-asserted.

Similarly, the second learned clause shown above represents an invariant related to the circuit-under-verification as follows: When the example circuit-under-verification shown in FIG. 6 operates, starting from any start state, at least one of the following statements must be true:
1. The output of logic gate N21 in the second cycle of operation is de-asserted.
2. The output of logic gate N20 in the second cycle of operation is de-asserted.
3. The output of logic gate N9 in the second cycle of operation is asserted.
4. The output of logic gate N9 in the first cycle of operation is asserted.
5. The output of logic gate N11 in the first cycle of operation is asserted.
6. The output of logic gate N1 in the first cycle of operation is de-asserted.

A learned clause also effectively summarizes the solution of a sub-problem by indicating that certain assignments of logic values to the variables of the target CNF formula (assignments for which each term in the learned clause evaluates to false) cause the entire target CNF formula to evaluate to false. Any other analysis of the circuit-under-verification can avoid solving the sub-problem again by using the learned clause to avoid considering such assignments. The example program uses externally learned clauses by concatenating them to the target CNF formula and performing BCP using the externally learned clauses together with the clauses of the target CNF formula.

In order to understand the simplification that results from using externally learned clauses in a second analysis of the circuit of the small example, consider the sequence of analysis acts performed by the example program in a hypothetical second analysis without using the externally learned clauses from the first analysis. In this hypothetical second analysis, the example program receives as input the file shown in Appendix A6. The start state is characterized by R1, R2 and R3 being de-asserted, and R4 being don't care. The target output is N24_2. The program performs a series of analysis acts, producing the output shown in Appendix A7. Specifically, the program performs the following analysis acts:
1. Performs Boolean constraint propagation (indicated as “Propagate”).
2. Pushes a new context (indicated as “Push”).
3. Case splits on node N1_1 (indicated as “CaseSplit”) and assigns node N1_1 to the logic value 1.
4. Performs Boolean constraint propagation.
5. Pushes a new context.
6. Case splits on node N1_2 and assigns node N1_2 to the logic value 1.
7. Performs Boolean constraint propagation.
8. Finds that the assigned values cause a conflict, diagnoses the cause of the conflict, learns a new clause “(!N20_{—}2 N11_{—}2 N9_{—}2 !N1_{—}2)” and adds the new clause to the clause database (indicated as “Diagnose”).
9. Pops contexts (indicated as “Pop”).
10. Propagates the values from the previous context using the newly added clause.
11. Finds that the assigned values cause a conflict, diagnoses the conflict, learns another new clause “(!N21_{—}2 !N20_{—}2 N9_{—}1 N11_{—}1 !N1_{—}1)” and adds the new clause to the clause database.
12. Pops contexts.
13. Propagates the values from the previous context using the newly added clause.
14. Finds that the assigned values cause a conflict and diagnoses the conflict to find an empty clause.
15. Determines that there is no satisfying assignment (indicated as “Inconsistent”) and exits.

Note that acts 5-10 of the hypothetical second analysis using the second start state are identical to acts 5-10 of the first analysis using the first start state.

By determining that the variables of the target CNF formula have no satisfying assignment, the example program has also determined that every possible sequence of logic values applied to the inputs of the circuit-under-verification fails to cause R4 of the circuit to be asserted (the target state) in two cycles of operation (the analysis depth D), starting from a state in which R1, R2, and R3 are all de-asserted (the second start state).

Now, consider the sequence of analysis acts performed by the example program in an actual second analysis of the circuit of the small example according to certain embodiments of the invention. The actual second analysis is similar to the hypothetical second analysis but uses the externally learned clauses from the first analysis. In this actual second analysis, the example program receives as input the file shown in Appendix A8, which includes the externally learned clauses from the first analysis. The start state is characterized by all of R1, R2, and R3 all being de-asserted, and R4 being don't care. The target output is N24_2. The program performs a series of analysis acts, producing the output shown in Appendix A9. Specifically, the program performs the following analysis acts:
1. Performs Boolean constraint propagation (indicated as “Propagate”).
2. Pushes a new context (indicated as “Push”).
3. Case splits on node N1_1 (indicated as “CaseSplit”) and assigns node N1_1 to the logic value 1.
4. Performs Boolean constraint propagation.
5. (Act eliminated due to externally learned clauses.)
6. (Act eliminated due to externally learned clauses.)
7. (Act eliminated due to externally learned clauses.)
8. (Act eliminated due to externally learned clauses.)
9. (Act eliminated due to externally learned clauses.)
10. (Act eliminated due to externally learned clauses.)
11. Finds that the assigned values cause a conflict, diagnoses the conflict, learns another new clause “(!N21_{—}2 !N20_{—}2 N9_{—}1 N11_{—}1 !N1_{—}1)” and adds the new clause to the clause database (indicated as “Diagnose”).
12. Pops contexts.
13. Propagates the values from the previous context using the newly added clause.
14. Finds that the assigned values cause a conflict and diagnoses the conflict to find an empty clause.
15. Determines that there is no satisfying assignment (indicated as “Inconsistent”) and exits.

Importantly, using the externally learned clauses, the example program correctly determines that the variables of the target CNF formula have no satisfying assignment, and therefore that every possible sequence of logic values applied to the inputs of the circuit-under-verification fails to cause R4 of the circuit to be asserted (the target state) in two cycles of operation (the analysis depth D), starting from a state in which R1, R2 and R3 are all de-asserted (the second start state).

As can be easily seen, the hypothetical second analysis without the externally learned clauses repeats acts 5-10 of the first analysis, but in the actual second analysis, using the two externally learned clauses from the first analysis causes the example program to avoid repeating acts 5-10 of the first analysis, thus simplifying the analysis.

Using the externally learned clauses from the first analysis can similarly simplify an analysis that succeeds in determining a satisfying assignment. In order to understand the simplification that results from using externally learned clauses in a third analysis that succeeds in finding a satisfying assignment, consider the sequence of analysis acts performed by the example program in a hypothetical third analysis of the circuit of the small example without using the externally learned clauses from the first analysis. In this hypothetical third analysis, the example program receives as input the file shown in Appendix A10. The start state is characterized by R1 being asserted, R2 and R3 being de-asserted, and R4 being don't care. The target output is N24_2. The program performs a series of analysis acts, producing the output shown in Appendix A11. Specifically, the program performs the following analysis acts:
1. Performs Boolean constraint propagation (indicated as “Propagate”).
2. Pushes a new context (indicated as “Push”) and propagates the assigned value.
3. Case splits on node N1_1 (indicated as “CaseSplit”) and assigns node N1_1 to the logic value 1.
4. Performs Boolean constraint propagation.
5. Pushes a new context.
6. Case splits on node N1_2 and assigns node N1_2 to the logic value 1.
7. Performs Boolean constraint propagation using the newly added clause.
8. Finds that the assigned values cause a conflict, diagnoses the cause of the conflict, learns a new clause “(!N20_{—}2 N11_{—}2 N9_{—}2 !N1_{—}2)” and adds the new clause to the clause database (indicated as “Diagnose”).
9. Pops contexts (indicated as “Pop”).
10. Performs Boolean constraint propagation using the newly added clause.
11. Finds that the assigned values cause a conflict, diagnoses the cause of the conflict, learns a new clause “(!N21_{—}2 !N6_{—}2 !N20_{—}2 N11_{—}2 N9_{—}1 !N1_{—}1)” and adds the new clause to the clause database.
12. Pops contexts.
13. Performs Boolean constraint propagation using the newly added clause.
14. Pushes a new context.
15. Case splits on input I1_1 and assigns node I1_1 to the logic value 1.
16. Performs Boolean constraint propagation.
17. Pushes a new context.
18. Determines a satisfying assignment including the following assignments (indicated as “Satisfiable”):
a. I1_1 is assigned to the logic value 1,
b. I2_1 is assigned to the logic value 0,
c. I1_2 is assigned to the logic value 1, and
d. I2_2 is assigned to the logic value 1.

Note that acts 5-10 of the hypothetical third analysis using the third start state are identical to acts 5-10 of the first analysis using the first start state.

Note that the satisfying assignment of the variables of the target CNF formula corresponds to the following sequence of logic values to apply to the inputs of the circuit-under-verification to cause the circuit to enter a state with R4 asserted (the target state) in two cycles of operation (the analysis depth D), starting from a state in which R1 is asserted and R2 and R3 are de-asserted (the third start state):
1. Apply the logic value 1 to the input I1 and the logic value 0 the input I2 in the first cycle of operation.
2. Apply the logic value 1 to the input I1 and the logic value 1 to the input I2 in the second cycle of operation.

Now, consider the sequence of analysis acts performed by the example program in an actual third analysis of the circuit of the small example according to certain embodiments of the invention. The actual third analysis is similar to the hypothetical third analysis but uses the externally learned clauses from the first analysis. In the actual third analysis, the example program receives as input the file shown in Appendix A12, which includes the externally learned clauses from the first analysis. The start state is characterized by R1 being asserted, R2 and R3 being de-asserted, and R4 being don't care. The target output is N24_2. The program performs a series of analysis acts, producing the output shown in Appendix A13. Specifically, the program performs the following analysis acts:
1. Performs Boolean constraint propagation (indicated as “Propagate”).
2. Pushes a new context (indicated as “Push”) and propagates the assigned value.
3. Case splits on node N1_1 (indicated as “CaseSplit”) and assigns node N1_1 to the logic value 1.
4. Performs Boolean constraint propagation.
5. (Act eliminated due to externally learned clauses.)
6. (Act eliminated due to externally learned clauses.)
7. (Act eliminated due to externally learned clauses.)
8. (Act eliminated due to externally learned clauses.)
9. (Act eliminated due to externally learned clauses.)
10. (Act eliminated due to externally learned clauses.)
11. Finds that the assigned values cause a conflict, diagnoses the cause of the conflict learns a new clause “(!N21_{—}2 !N20_{—}2 N9_{—}1 N11_{—}1 !N1_{—}1)” and adds the new clause to the clause database (indicated as “Diagnose”).
12. Pops contexts (indicated as “Pop”).
13. Performs Boolean constraint propagation using the newly added clause.
14. Pushes a new context.
15. Case splits on input I1_1 and assigns node I1_1 to the logic value 1.
16. Performs Boolean constraint propagation.
17. Pushes a new context.
18. Determines a satisfying assignment including the following assignments (indicated as “Satisfiable”):
a. I1_1 is assigned to the logic value 1,
b. I2_1 is assigned to the logic value 0,
c. I1_2 is assigned to the logic value 1, and
d. I2_2 is assigned to the logic value 1.

Importantly, using the externally learned clauses, the example program correctly determines a satisfying assignment of the variables of the target CNF formula, corresponding to a sequence of logic values to apply to the inputs of the circuit-under-verification to cause the circuit to enter a state with R4 asserted (the target state) in two cycles of operation (the analysis depth D), starting from a state in which R1 is asserted and R2 and R3 are de-asserted (the third start state).

As can be easily seen, the hypothetical third analysis without the externally learned clauses repeats acts 5-10 of the first analysis, but in the actual third analysis, using the two externally learned clauses from the first analysis causes the example program to avoid repeating acts 5-10 of the first analysis, thus simplifying the analysis.

Just as storing clauses learned during a first analysis using a first start state and using the stored clauses during a second analysis using a second start state simplifies the second analysis, storing clauses learned during the second analysis using the second start state and using the stored clauses during a third and other analyses using a third and other start states simplifies the third and other analyses, reducing the time required for analysis using each of a large set of start states determined during simulation.

For digital circuits other than the example circuit, the method of certain embodiments of the invention may allow substantially more simplification of the analysis than is illustrated above. For example, during the first analysis, the clause “(!N)” may be learned, where “N” is the name of the target output of the time-frame-expanded netlist. In this case, the first “Propagate” act performed by the example program in the second analysis using the externally learned clause will immediately determine that the variables of the target CNF formula have no satisfying assignment, because, regardless of whether N is asserted or de-asserted, one of the two clauses “(N)” and “(!N)” evaluates to false. In this case, the analysis is greatly simplified.

In general, the more similar the start states are, the more simplification may result from re-using the learned invariants.

For illustrative purposes, the size of the example circuit is small and the depth of analysis is also small, therefore the number of clauses learned during each analysis using each start state is small. For large circuits (for example, circuits containing 10,000 logic gates or more) and for large analysis depths (for example, analysis depths of 10 cycles or more) the number of externally learned clauses may be much greater than shown in this example (for example, 1,000 externally learned clauses or more). Also, the clauses learned during each analysis using each simulation state of a large set of simulation states (for example, 100 simulation states) can be saved and used in every subsequent analysis. As a result, for large circuits, large analysis depths and large sets of simulation states, the number of redundant analysis acts that can be skipped due to using externally learned clauses may be much greater than shown in this example. Therefore, the amount of simplification of the analysis may be much greater than shown in this example.

Therefore, the method of certain embodiments of this invention reduces the time required for a programmed computer to automatically check if the digital circuit can enter a state indicative of a pre-determined defective behavior, starting from any of a set of simulation states. Therefore, the method of certain embodiments of this invention reduces the time required for functional verification of the digital circuit.

Several embodiments of the invention use initial states representing corner-case modes of operation determined during simulation of the digital circuit. During development of a large digital circuit, design verification engineers may develop hundreds of different directed simulation test programs, each targeting a different corner-case behavior. The states of the circuit determined during simulation of the directed simulation tests can be used as initial states representing corner-case modes of operation of the circuit. BMC using initial states determined during simulation is briefly described in “Deep formal verification powers assertions”, Curtis Widdoes and Richard Ho, EEdesign.com, Apr. 18, 2002, and this article is incorporated by reference herein in its entirety.

Several such embodiments simplify BMC analysis using multiple start states (e.g. representing each of several different corner-case modes of operation) by learning information during each BMC analysis using each start state and using the learned information to simplify additional BMC analyses using different start states, thus reducing the time required to perform the additional BMC analyses and reducing the time required for functional verification of the digital circuit.

Several embodiments of the invention simplify and accelerate determination of the “proof radius” of a digital circuit, as described in the commonly owned U.S. patent application, application Ser. No. 10/174,379, [Attorney Docket No. 0IN003 US], filed Jun. 17, 2002, entitled “Measure of Analysis Performed In Property Checking” filed by Jeremy Rutledge Levitt et al. that is incorporated by reference herein in its entirety. Specifically, in such embodiments, by systematically increasing C from 1 up to a finite limit, and repeatedly applying the method of the invention for each value of C, to check if the digital circuit can enter a pre-determined target state in C cycles of operation, starting from a pre-determined start state, determination is made that the proof radius is equal to the finite limit.

In certain embodiments of the invention, if the two start states are different from one another, then the two analyses using the two start states are considered to be different from one another, even if the analyses use the same target state and the same analysis depth, therefore, in such embodiments, learned clauses that are transferred between the two analyses are considered to be externally learned clauses as discussed above. In several such embodiments, a majority of the externally learned clauses have more than three terms.

In certain embodiments of the invention, if the two start states are different from one another, and the two target states are different from one another, and the two analysis depths are different from one another, then the corresponding two analyses are considered to be different from one another, therefore, in such embodiments, learned clauses that are transferred between the two analyses are considered to be externally learned clauses as discussed above.

Numerous modifications and adaptations of the embodiments described herein will be apparent to a person skilled in the art of EDA in view of this disclosure (including the software and documentation in Appendices A1-A14 attached hereto). Other embodiments of a method in accordance with the invention include one or more of the following steps: automatically converting a description of the circuit-under-verification written in either the Verilog or VHDL hardware description language into a netlist representation, using, for example, a commercially available logic synthesis product such as Design Compiler available from Synopsys; optimizing the netlist representation of the circuit-under-verification before the first analysis using the first start state; optimizing the netlist representation of the circuit-under-verification using invariants learned during the first analysis using the first start state; optimizing the CNF formula representing the netlist of the circuit-under-verification before the first analysis using the first start state; optimizing the CNF formula representing the netlist of the circuit-under-verification using invariants learned during the first analysis using the first start state; optimizing the time-frame-expanded netlist of the circuit-under-verification using invariants learned during the first analysis using the first start state; optimizing the CNF formula representing the time-frame-expanded netlist of the circuit-under-verification using invariants learned during the first analysis using the first start state; using invariants learned during the first analysis using the first start state to simplify the second analysis using the second start state, wherein the second analysis uses a different analysis depth than the first analysis; using invariants learned during the first analysis using the first start state to simplify the second analysis using the second start state, wherein the target state of the second analysis is different from the target state of the first analysis; using invariants learned during the first analysis using the first start state to simplify the second analysis using the second start state, wherein the algorithm used for the first analysis is different from a SAT algorithm; and using invariants learned during the first analysis using the first start state to simplify the second analysis using the second start state, wherein the algorithm used for the second analysis is different from a SAT algorithm.

Therefore, many such variations of the embodiments described herein are encompassed by the attached claims.

The following is an explanation of various functions of an example Boolean satisfiability program that is listed in Appendix A14 in file APPENDIXA.txt the attached CD-ROM.

inline void Push (void)

Push( ) checkpoints the current set of assignments, and identifies the checkpoint with the value of the global integer variable “d1”. The value of d1 is then incremented.

void Pop (int bktLevel)

Let integer “bktLevel” be the argument to this function. Pop( ) restores to the current set of assignments the checkpointed set of assignments identified by bktLevel. All checkpoints identified with values greater than or equal to bktLevel are deleted. The global integer variable “d1” is assigned the value of bktLevel.

const ClsC* Propagate (void)

Propagate( ) performs unit propagation. It continuously loops over all the clauses in the global list of clauses, until either (1) an unsatisfiable clause is detected or (2) the list contains no unit clauses. If a unit clause is encountered while looping over the list of clauses, the function performs unit propagation by adding the implied assignment to the set of current assignments. This also converts the unit clause to a satisfied clause. If an unsatisfiable clause is encountered, the function immediately returns the unsatisfied clause. If the list contains no unit clauses or unsatisfiable clauses, the function returns NULL.

VarC* CaseSplit (void)

Loop over the list of variables. Return the first unassigned variable in the list. If all the variables in the list are assigned, return NULL.

int Diagnose (const ClsC* cls)

Diagnose( ) identifies a set of assignments, say A, that is a subset of a checkpointed set of assignments and that logically implies an assignment, say var=˜val, where var=val is in the current set of assignments. A “conflict” clause is built that will unit propagate the assignment var=˜val given the the set of assignments A. The conflict clause is added to the global list of clauses. The function returns the identity of the least recently checkpointed set of assignments in which the conflict clause is a unit clause. The steps performed are:
1. Initialization: Let “cls” be an unsatisfied clause passed in as an argument to this function. A set of variables, called “confVars”, is initialized with the variables appearing in cls. An empty set of literals, called “confLits”, is created. Integers “bktLevel” and “confLevel” are initialized to −1.
2. Looping: The variables in the set confVars are processed in order of initial insertion. For each variable, if the variable assignment is contained in a checkpointed set of assignments or if the variable assignment was not the result of unit propagation,
   (1) the variable and its assignment is inserted into the set confLits and
   (2) integers confLevel and bktLevel are updated so that they identify the respective least recently checkpointed sets of assignments in which the most and second most recently assigned variables in confLits are assigned.
Otherwise,
   (1) the variables in the clause responsible for the unit-propagation of the assignment to the variable are inserted into set confVars.
3. Conflict clause construction: A clause is built from the items in the set confLits. This clause is added to the global list of clauses.
4. Temporary flag settings are cleared. The value of bktLevel is returned.

bool Satisfy (void)

Satisfy( ) is the entry-point to the SAT solver. It loops continuously over the following steps until either a consistent set of assignments for all variables has been found, or the initial variable assignments (i.e. the initial state plus the desired assignment in the target state) are proven to be inconsistent. The steps are:
1. Propagate the current variable assignments (see explanation for Propagate( ) routine).
2. If propagation detects that the current set of variable assignments is inconsistent, then:
   2_{—}1. Learn a conflict clause (see explanation for Diagnose( ) routine).
   2_{—}2. If conflict clause is empty, exit the loop; the initial set of variable assignments has been proven to be inconsistent. Otherwise, restore the checkpointed set of assignments (see explanation for Pop( ) routine) identified by the call to Diagnose( ).
Otherwise:
   2_{—}3. Checkpoint the current set of assignments (see explanation for Push( ) routine).
   2_{—}4. If there are no unassigned variables, exit the loop; a consistent set of variable assignments to all variables has been found. Otherwise, select an unassigned variable (see explanation for CaseSplit( ) routine) and assign it.

void Read (char *filename)

Read( ) inputs the unrolled netlist from a file, converting each gate to a set of CNF clauses and adding the clauses to the global list of clauses. The function also reads in the values of the register bits in the initial state and the desired values of the register bits in the target state, and creates unit clauses that unit propagate the values to the corresponding variables.

int main (int argc, char **argv)

main( ) reads in a SAT problem from the file specified on the command line, prints the value of the initial state and calls the SAT solver. If the SAT problem is satisfiable, the satisfying input assignments are printed. The clauses comprising the SAT problem and the “conflict” clauses learned during the analysis performed by the SAT solver are optionally printed depending on the verbosity specified on the command line.

1. A method for functional verification of a description of a digital circuit, the method comprising processes of:
analyzing the digital circuit (hereinafter “first analysis”) to check if the digital circuit can enter a predetermined state (hereinafter “first target state”) in a predetermined first number of cycles of operation, starting from another predetermined state (hereinafter “first start state”)
determining information related to the digital circuit learned during said first analysis (“learned information”); and
analyzing the digital circuit (hereinafter “second analysis”), to check if the digital circuit can enter yet another predetermined state (hereinafter “second target state”) in a predetermined second number of cycles of operation, starting from still another predetermined state (hereinafter “second start state”), different from the first start state, using the learned information from the first analysis, wherein the learned information is used to simplify calculations in the second analysis to check if the digital circuit can enter the second target state in the predetermined second number of cycles of operation, starting from the second start state.

2. The method of claim 1 wherein the learned information represents an invariant related to the digital circuit.

3. The method of claim 1 wherein the first analysis determines that every possible sequence of logic values applied to inputs of the digital circuit fails to cause the digital circuit to enter the first target state in the first number of cycles of operation, starting from the first start state.

4. The method of claim 1 wherein the first analysis determines a sequence of logic values to apply to inputs of the digital circuit to cause the digital circuit to enter the first target state in the first number of cycles of operation, starting from the first start state.

5. The method of claim 1 wherein the second analysis determines that every possible sequence of logic values applied to inputs of the digital circuit fails to cause the digital circuit to enter the second target state in the second number of cycles of operation, starting from the second start state.

6. The method of claim 1 wherein the second analysis determines a sequence of logic values to apply to inputs of the digital circuit to cause the digital circuit to enter the second target state in the second number of cycles of operation, starting from the second start state.

7. The method of claim 1 wherein the learned information is used during the second analysis to avoid repeating at least part of the analysis performed during the first analysis.

8. The method of claim 1 wherein the first analysis comprises a plurality of analysis acts and the learned information represents the results of performing at least one of the analysis acts.

9. The method of claim 1 wherein the first analysis comprises a plurality of analysis acts and the learned information is used during the second analysis, to avoid repeating at least one of the analysis acts.

10. The method of claim 1 wherein the first analysis solves a plurality of sub-problems and the learned information represents the results of solving at least one of the sub-problems.

11. The method of claim 1 wherein the first analysis solves a plurality of sub-problems and the learned information is used during the second analysis to avoid solving at least one of the sub-problems.

12. The method of claim 1 wherein the first target state is indicative of a defective behavior of the digital circuit.

13. The method of claim 1 wherein the second target state is indicative of a defective behavior of the digital circuit.

14. The method of claim 1 wherein the first number of cycles is the same as the second number of cycles.

15. The method of claim 1 wherein the first number of cycles is different from the second number of cycles.

16. The method of claim 1 wherein the first target state is the same as the second target state.

17. The method of claim 1 wherein the first target state is different from the second target state.

18. The method of claim 1 wherein the first start state is a reset state of the digital circuit.

19. The method of claim 1 wherein the second start state is a reset state of the digital circuit.

20. The method of claim 1 wherein the first start state is determined by simulating the digital circuit.

21. The method of claim 1 wherein the second start state is determined by simulating the digital circuit.

22. The method of claim 1 wherein the learned information is stored in a database.

23. The method of claim 1 wherein the learned information is represented as a CNF clause.

24. The method of claim 1 wherein the learned information is represented as a CNF clause having more than three terms.

25. The method of claim 1 wherein the learned information is represented as one or more logic gates.

25. The method of claim 1 wherein the learned information is represented as “C” code.

27. The method of claim 1 wherein the learned information is represented as a data structure interpreted by a “C” program.

28. The method of claim 1 wherein the learned information is represented as “C++” code.

29. The method of claim 1 wherein the learned information is represented as a data structure interpreted by a “C++” program.

30. The method of claim 1 wherein the learned information is represented as “Java” code.

31. The method of claim 1 wherein the learned information is represented as a data structure interpreted by a “Java” program.

32. The method of claim 1 wherein the digital circuit is combinational.

33. The method of claim 1 wherein the digital circuit is sequential.

34. The method of claim 1 wherein the digital circuit is sequential and for a majority of the state registers in the digital circuit, the logic value of the state register in the first start state is identical to the logic value of the same state register in the second start state.

35. The method of claim 1 wherein the digital circuit is described using the Verilog language.

36. The method of claim 1 wherein the digital circuit is described using the VHDL language.

37. A method for functional verification of a description of a digital circuit, the method comprising:
satisfiability (SAT) checking a time-frame expansion of the circuit for transition from a predetermined start state to a predetermined target state, and during said satisfiability checking, generating a plurality of conjunctive normal form (CNF) clauses (hereinafter “learned clauses”); and
using at least one of the learned clauses to perform another satisfiability (SAT) checking of the circuit, for transition from a different start state.
